(19) United States
(12) Patent Application Publication
(10) Pub. No.: US 2024/0166977 A1
(43) Pub. Date: May 23, 2024

(54) PROCESS FOR MAKING A PARTICULATE COATED ORGANIC SALT, AND PARTICULATE COATED SALT

(71) Applicant: BASF SE, Ludwigshafen am Rhein (DE)

(72) Inventors: Verena STREMPEL, Ludwigshafen (DE); Marta REINOSO GARCIA, Ludwigshafen (DE); Daniel LOEFFLER, Ludwigshafen (DE); Carsten SUELING, Ludwigshafen (DE)

(21) Appl. No.: 18/548,582

(22) PCT Filed: Feb. 24, 2022
(86) PCT No.: PCT/EP2022/054695

§ 371 Date: Sep. 1, 2023

(30) Foreign Application Priority Data
Mar. 4, 2021 (EP) 21160598.5

(51) Int. Cl. C11D 17/00; C11D 3/12; C11D 3/16; C11D 3/33

(52) U.S. Cl. CPC C11D 17/0039; C11D 3/1206; C11D 3/168; C11D 3/33; C11D 17/0091; C11D 2111/14

(57) ABSTRACT

Process for making a particulate coated chelating agent (A) wherein said process comprises the following steps:
(a) Providing a granule or powder containing an alkali metal salt of methyl glycine diacetic acid (MGDA) or glutamic acid diacetic acid (GLDA), preferably with a moisture content in the range of from 1 to 15% by weight,
(b) treating said salt with a metal alkoxide or metal halide or metal amide or alkyl metal compound or with an alkoxide, amide, halide or alkyl compound of silicon,
(c) treating the material obtained in step (b) with moisture or
(c*) with ozone,
(d) optionally, repeating the sequence of steps (b) and (c) once to 25 times.

Process for making a particulate coated chelating agent (A), wherein the coating is preferably a continuous one, determined by transmission electron spectroscopy, in that no non-coated portions may be detected, wherein said process comprises the following steps:
(a) Providing a granule or powder containing an alkali metal salt of methyl glycine diacetic acid (MGDA) or glutamic acid diacetic acid (GLDA), preferably with a moisture content in the range of from 1 to 15% by weight,
(b) treating said salt with a metal alkoxide or metal halide or metal amide or alkyl metal compound or with an alkoxide, amide, halide or alkyl compound of silicon,
(c) treating the material obtained in step (b) with moisture or
(c*) with ozone,
(d) optionally, repeating the sequence of steps (b) and (c) once to 25 times.

Chelating agents of the aminocarboxylate type such as methyl glycine diacetic acid (MGDA) and glutamic acid diacetic acid (GLDA) and their respective alkali metal salts are useful sequestrants for alkaline earth metal ions such as Ca²⁺ and Mg²⁺. A lot of aminocarboxylates show good biodegradability and are thus environmentally friendly. For that reason, they are recommended and used for various purposes such as laundry detergents and for automatic dishwashing (ADW) formulations, in particular for so-called phosphate-free laundry detergents and phosphate-free ADW formulations. An aminocarboxylate of particular relevance is MGDA.

Granules and powders have the advantage of being essentially water-free. That means that in case of shipping, no water has to be shipped, and costs for extra weight can be avoided. However, still many powders and granules show the problem of yellowing, in particular when contacted with chlorine-free bleaching agents such as, but not limited to inorganic peroxides. Examples of inorganic peroxides are sodium perborate, sodium persulfate and in particular sodium percarbonate.

A lot of additives have been tried in order to limit such yellowing. Most of them, however, either deteriorate the activity of the bleaching agent or considerably slow down the dissolution of the complexing agent, both effects being undesirable.

WO 2009/103822 discloses a process for making granules of MGDA by heating a slurry of MGDA with a high solids content and spray drying such highly concentrated slurry with an air inlet temperature in the range of from 50 to 120° C.

WO 2015/121170 recommends to spray-dry or spray granulate MGDA or related aminocarboxylates with certain (co)polymers. WO 2015/121170 discloses that such granules and powders show a reduced tendency of yellowing.

However, efficient ways to protect MGDA and GLDA from yellowing are still attractive. It is desired to provide chelating agents in solid form that are less hygroscopic and give no or little raise to yellowing upon contact with peroxides such as percarbonate. It is therefore an objective of the present invention to provide chelating agents in solid form that are less hygroscopic and give no or little raise to yellowing upon contact with percarbonate, and it is an objective of the present invention to provide a process for manufacturing such chelating agents in solid form.

Accordingly, the process as defined at the outset has been found, hereinafter also referred to as inventive process or process according to the (present) invention. The inventive process comprises steps (a) to (d), in the context of the present invention also referred to as step (a), step (b), step (c) and step (d) or briefly as (a), (b), (c) and (d).

In step (a), a powder or granule containing an alkali metal salt of methyl glycine diacetic acid (MGDA) or glutamic acid diacetic acid (GLDA) is provided.

In the course of the present invention, powders are particulate materials that are solids at ambient temperature and that preferably have an average particle diameter in the range of from 1 μm to less than 0.1 mm, preferably 10 μm up to 75 μm. The average particle diameter of powders of chelating agent (A) can be determined, e.g., by sieving methods and refers to the volume average (D50).

In the course of the present invention, granules are particulate materials that are solids at ambient temperature and that preferably have an average particle diameter in the range of from 0.1 mm to 2 mm, more preferably 250 to 850 μm. The average particle diameter of granules of chelating agents (A) can be determined, e.g., by optical or preferably by sieving methods. Sieves employed may have a mesh in the range of from 60 to 1,250 μm (D50).

Granules and powders of chelating agent (A) preferably contain residual moisture, moisture referring to water including water of crystallization and adsorbed water. The amount of water may be in the range of from 1 to 15% by weight, preferably 1.5 to 10% by weight, referring to the total solids content of the respective powder or granule, and may be determined by Karl-Fischer-titration or by thermogravimetric measurements, for example heating under an inert gas such as, but not limited to N₂, and measuring the mass change.

Particles of powders of chelating agent (A) may have regular or irregular shape. Preferred shapes of particles of powders are spheroidal or even spherical shapes. Such powders may be obtained by spray-drying.

Particles of granules of chelating agent (A) may have regular or irregular shapes. Preferred shapes of particles of granules are spheroidal or even spherical shapes. Such granules may be obtained by spray granulation, for example in a fluidized bed or in a spouted bed.

In the context of the present invention, alkali metal salts of methylglycine diacetic acid are selected from lithium salts, potassium salts and preferably sodium salts of methylglycine diacetic acid. Methylglycine diacetic acid can be partially or preferably fully neutralized with the respective alkali. In a preferred embodiment, an average of from 2.7 to 3 COOH groups of MGDA is neutralized with alkali metal, preferably with sodium. In a particularly preferred embodiment, chelating agent (A) is the trisodium salt of MGDA.

Likewise, alkali metal salts of glutamic acid diacetic acid are selected from lithium salts, potassium salts and preferably sodium salts of glutamic acid diacetic acid. Glutamic acid diacetic acid can be partially or preferably fully neutralized with the respective alkali. In a preferred embodiment, an average of from 3.5 to 4 COOH groups of MGDA is neutralized with alkali metal, preferably with sodium. In a particularly preferred embodiment, chelating agent (A) is the tetrasodium salt of GLDA.

Alkali metal salts of MGDA can be selected from the racemic mixtures, the D-isomers and the L-isomers, and from mixtures of the D- and L-isomers other than the racemic mixtures. Preferably, MGDA and its respective alkali metal salts are selected from the racemic mixture and from mixtures containing in the range of from 55 to 85 mole-% of the L-isomer, the balance being D-isomer. Particularly preferred are mixtures containing in the range of from 60 to 80 mole-% of the L-isomer, the balance being D-isomer.

The distribution of L- and D-enantiomer can be determined by measuring the polarization (polarimetry) or preferably by chromatography, for example by HPLC with a chiral column, for example with one or more cyclodextrins as immobilized phase. Preferred is determination of the ee by HPLC with an immobilized optically active ammonium salt such as D-penicillamine.

GLDA and its respective alkali metal salts can be selected from the racemic mixtures, the D-isomers and the L-isomers, and from mixtures of the D- and L-isomers other than the racemic mixtures. Preferably, alkali metals of GLDA are selected from mixtures containing in the range of from 75 to 99 mole-% of the L-isomer, the balance being D-isomer. Particularly preferred are mixtures containing in the range of from 80 to 97.5 mole-% of the L-isomer, the balance being D-isomer.

In any way, minor amounts of chelating agent (A) may bear a cation other than alkali metal. It is thus possible that minor amounts, such as 0.01 to 5 mol-% of total chelating agent (A) bear alkali earth metal cations such as Mg²⁺ or Ca²⁺, or an Fe²⁺ or Fe³⁺ cation.

In one embodiment of the present invention, chelating agent (A) may contain one or more impurities that may result from the production of the respective chelating agent. In the case of alkali metals of MGDA, such impurities may be selected from alkali metal propionate, lactic acid, alanine or the like. Such impurities are usually present in minor amounts. “Minor amounts” in this context refer to a total of 0.1 to 1% by weight, referring to chelating agent (A). In the context of the present invention, such minor amounts are neglected when determining the composition of inventive powder or inventive granule, respectively.

In one embodiment of the present invention, powder or granule of chelating agent (A) that is provided in step (a) has a white or pale yellow appearance.

In one embodiment of the present invention, powder or granule of chelating agent (A) as provided in step (a) contains at least one additive selected from silica, silicates, inorganic salts, (co)polymers (B) and builders other than chelating agent (A) and organic (co)polymers (B). Such additive(s) may also be referred to as additive(s) (B). Examples of useful additives (B) are, for example, titanium dioxide, sodium carbonate, potassium carbonate, sugar, silica gel, sodium silicate, potassium silicate, and (co)polymers (B) such as, but not limited to poly(meth)acrylates, polyalkylenimines such as polyethylenimines, alkoxylated polyethylenimines, carboxymethylated polyethylenimines, and polyvinyl alcohol. Polyvinyl alcohol in the context of the present invention refers to completely or partially hydrolyzed polyvinyl acetate. In partially hydrolyzed polyvinyl acetate, at least 95 mol-%, preferably at least 96 mol-% of the acetate groups have been hydrolyzed. Examples of complexing agents other than aminocarboxylic acid (A) are alkali metal citrates. Another possible class of additives is phosphonates, for example the alkali metal salts of 1-hydroxyethane 1,1-diphosphonic acid, “HEDP”.

In one embodiment of the present invention, powder or granule of chelating agent (A) as provided in step (a) contains 0.05 to 30% by weight of additive(s) (B) in total, the percentage referring to the entire aqueous slurry. The amount of polyethylenimines or alkoxylated polyethylenimines is preferably in the range of from 0.05 to 0.5% by weight, the amount of silicate may be up to 30% by weight.

Examples of (co)polymers (B) are poly(meth)acrylates including copolymers of (meth)acrylic acid with maleic acid or AMPS, polyalkylenimines, especially polyethylenimines, and substituted polyalkylenimines, for examples polycarboxymethylated polyethylenimines, polycarboxyethylated polyethylenimines, and polyaylkoxylated polyethylenimines, especially polyethoxylated polyethylenimines.

Preferred examples of polycarbomethoxylated polyethylenimines are polyethylenimines in which 20 to 90 mole-% of the N-atoms bear at least one CH₂COO⁻ group, and their respective alkali metal salts, especially their sodium salts.

In one embodiment of the present invention said powder or granule of chelating agent (A) as provided in step (a) contains in the range of from 80 to 99.9% by weight chelating agent (A) and 0.1 to 20% by weight (co)polymer (B), percentages referring to the total solids content of said aqueous slurry or solution.

In one embodiment of the present invention, (co)polymers (B) selected from poly(meth)acrylic acid have an average molecular weight M_{w} in the range of from 1,200 to 30,000 g/mol, determined by gel permeation chromatography and referring to the respective free acid, if applicable.

In another embodiment of the present invention, said powder or granule of chelating agent (A) is free from additive(s) (B).

In a preferred embodiment of the present invention, alkali metal salt of MGDA corresponds to general to general formula (I)

[CH₃—CH(COO)—N(CH₂—COO)₂]M₃₋ₓHₓ (I)

with

M being Na or K or combinations thereof, preferred is Na, and

x being in the range of from zero to 0.5 and corresponding to the average value.

Step (b) includes treating said salt with a metal alkoxide or metal halide or metal amide or alkyl metal compound or with an alkoxide, amide, halide or alkyl compound of silicon.

In one embodiment of the present invention, such metal is selected from aluminum and transition metals such as zinc, titanium or zirconium.

Metal alkoxides may be selected from C₁-C₄-alkoxides of aluminum and of transition metals. Preferred transition metals are titanium and zirconium. Examples of alkoxides are methanolates, hereinafter also referred to as methoxides, ethanolates, hereinafter also referred to as ethoxides, propanolates, hereinafter also referred to as propoxides, and butanolates, hereinafter also referred to as butoxides. Specific examples of propoxides are n-propoxides and isopropoxides. Specific examples of butoxides are n-butoxides, iso-butoxides, sec.-butoxides and tert.-butoxides. Combinations of alkoxides are feasible as well.

Preferred examples of metal C₁-C₄-alkoxides are Ti[OCH(CH₃)_{2]4}, Ti(OC₄H₉)₄, Zr(OC₄H₉)₄, Zr(OC₂H₅)₄, Al(OCH₃)₃, Al(OC₂H₅)₃, Al(O-n-C₃H₇)₃, Al(O-iso-C₃H₇)₃, Al(O-sec.-C₄H₉)₃, and Al(OC₂H₅)(O-sec.-C₄H₉)₂.

Examples of metal alkyl compounds are Zn(C₂H₅)₂, and preferably aluminum alkyl compounds are trimethyl aluminum, triethyl aluminum, triisobutyl aluminum, and methyl alumoxane.

Metal amides are sometimes also referred to as metal imides. Examples of metal amides are Zr[N(C₂H₅)₂)]₄, Zr[N(CH₃)_{2]4}, Zr[(CH₃)N(C₂H₅)₃], Ti[N(C₂H₅)₂)]₄, and Ti[N(CH₃)_{2]4}.

Examples of metal halides are halides that are volatile, for example with a boiling point—or sublimation temperature, as the case may be, of less than 300° C. at ambient pressure, preferably less than 250° C. Specific examples are TiCl₄, ZrCl₄, and AlCl₃.

Examples of alkoxides of silicon (Si) are C₁-C₄-alkoxides of silicon, for example Si(OCH₃)₄, Si(OC₂H₅)₄, Si(O-n-C₃H₇)₄, Si(O-iso-C₃H₇)₄, Si(O-sec.-C₄H₉)₄, and Si(OC₂H₅)₂(O-sec.-C₄H₉)₂, with Si(OCH₃)₄ and Si(OC₂H₅)₄, being preferred. Examples of amides of silicon are Si[N(C₂H₅)₂)]₄, Si[N(CH₃)_{2]4}, HSi[N(CH₃)_{2]3}, H₂Si[N(CH₃)_{2]2}, and H₃Si[N(CH₃)₂]. Examples of halides of silicon are SiCl₄ and SiBr₄. Examples of alkyl compound of silicon are Si(CH₃)₄, Si(C₂H₅)₄, Si(n-C₃H₇)₄, and mixed derivatives such as Si(OC₂H₅)₂(CH₃)₂, methyl trichlorosilane, and trimethyl chlorosilane.

In one embodiment of the present invention, the alkyl metal compound in step (b) is selected from trimethylaluminum and triethylaluminum and diethyl zinc.

In one embodiment of the present invention, the alkoxide, amide, halide or alkyl compound of silicon in step (b) is selected from silicon amides such as tris-dimethylamino silane and mono-dimethylaminosilane, halides of silicon are selected from chlorosilanes, for example H—SiCl₃, SiCl₄, and alkoxides of silicon are selected from C₁-C₄-alkoxysilanes such as Si(OCH₃)₄ and Si(OC₂H₃)₄. More preferred are HSi[N(CH₃)_{2]3} and H₃Si[N(CH₃)₂] and SiCl₄ and Si(OC₂H₃)₄.

Particularly preferred compounds are selected from C₁-C₄-alkoxides of Ti and Zr and C₁-C₄-dialkylamides of Si, and metal alkyl compounds, and even more preferred is trimethyl aluminum.

In one embodiment of the present invention, the amount of metal alkoxide or metal amide or alkyl metal compound or of the respective compound of silicon used in step (b) is in the range of 0.1 to 5 g/kg powder or granule of chelating agent (A).

Preferably, the amount of metal alkoxide or metal amide or metal halide or alkyl metal compound or of compound of silicon, respectively, is calculated to amount to 80 to 200% of a monomolecular layer on the particular granule or powder per cycle.

Step (b) of the inventive process as well as step (c)—that will be discussed in more detail below—may be carried out in the same or in different vessels.

In one embodiment of the present invention, step (b) is performed in a rotary reactor, in a free fall mixer, in a continuous vibrating bed or in a fluidized bed, for example a stirred fluidized bed.

In one embodiment of the present invention, step (b) is carried out at a temperature in the range of from 40 to 175° C., preferably 50 to 160° C.

In a preferred embodiment of the present invention, the duration of step (b) is in the range of from 1 minute to 2 hours, preferably 2 minutes up to 60 minutes. The higher the amount of chelating agent (A) the longer the preferred duration of step (b).

Preferably, step (b) is a self-limiting reaction and the performance of step (b) is adapted accordingly. That means that after a certain time, unreacted metal alkoxide or metal amide or metal halide or alkyl metal compound or of compound of silicon, respectively, is detected in the off-gas, and step (b) is terminated.

A treated granule or powder is obtained from step (b).

In a third step, in the context of the present invention also referred to as step (c), the treated granule or powder obtained in step (b) is treated with moisture.

In one embodiment of the present invention, step (c) is carried out at a temperature in the range of from 40 to 175° C., preferably 50 to 150° C.

In one embodiment of the present invention, step (c) is carried out at normal pressure but step (c) may as well be carried out at reduced or elevated pressure. For example, step (c) may be carried out at a pressure in the range of from 5 mbar to 1 bar above normal pressure, preferably 10 to 250 mbar above normal pressure. In the context of the present invention, normal pressure is 1 atm or 1013 mbar. In other embodiments, step (c) may be carried out at a pressure in the range of from 150 mbar to 560 mbar above normal pressure.

Steps (b) and (c) may be carried out at the same pressure or at different pressures, preferred is at the same pressure.

Said moisture may be introduced, e.g., by treating the material obtained in accordance with step (b) with moisture saturated inert gas, for example with moisture saturated nitrogen or moisture saturated noble gas, for example argon. Saturation may refer to normal conditions or to the reaction conditions in step (c).

In one embodiment of the present invention, step (c) is performed in a rotary reactor, in a free fall mixer, in a continuous vibrating bed or a fluidized bed, for example in a stirred fluidized bed.

In a preferred embodiment of the present invention, the duration of step (c) is in the range of from 1 minute to 1 hour, preferably 2 minutes up to 30 minutes.

In one embodiment of the present invention, the reactor in which the inventive process is carried out is flushed or purged with an inert gas between steps (b) and (c), for example with dry nitrogen or with dry argon. Suitable flushing—or purging—times are 1 second to 60 minutes. It is preferred that the amount of inert gas is sufficient to exchange the contents of the reactor of from one to 15 times. By such flushing or purging, the production of by-products such as separate particles of reaction product of metal alkoxide or metal amide or alkyl metal compound, respectively, with water can be avoided. In the case of the couple trimethyl aluminum and water, such by-products are methane and alumina or trimethyl aluminum that is not deposited on the particulate material, the latter being an undesired by-product. Said flushing also takes place after step (c), thus before another step (b).

In one embodiment of the present invention, each flushing step between steps (b) and (c) has a duration in the range of from one minute to sixty minutes.

In one embodiment of the present invention, the reactor is evacuated between steps (b) and (c). Said evacuating may also take place after step (c), thus before another step (b). Evacuation in this context includes any pressure reduction, for example 10 to 1,000 mbar (abs), preferably 10 to 500 mbar (abs).

Each of steps (b) and (c) may be carried out in a fixed bed reactor, in a fluidized bed reactor, in a forced flow reactor or in a mixer, for example in a compulsory mixer or in a free-fall mixer. Examples of fluidized bed reactors are spouted bed reactors, non-stirred fluidized bed reactors and stirred fluidized bed reactors. Examples of compulsory mixers are ploughshare mixers, paddle mixers and shovel mixers. Preferred are ploughshare mixers. Preferred ploughshare mixers are installed horizontally, the term horizontal referring to the axis around which the mixing element rotates. Preferably, the inventive process is carried out in a shovel mixing tool, in a paddle mixing tool, in a Becker blade mixing tool and, most preferably, in a ploughshare mixer in accordance with the hurling and whirling principle. Free fall mixers are using the gravitational force to achieve mixing. In a preferred embodiment, steps (b) and (c) of the inventive process are carried out in a drum or pipe-shaped vessel that rotates around its horizontal axis. In a more preferred embodiment, steps (b) and (c) of the inventive process are carried out in a rotating vessel that has baffles.

In one embodiment of the present invention, the rotating vessel has in the range of from 2 to 100 baffles, preferably 2 to 20 baffles. Such baffles are preferably flush mount with respect to the vessel wall.

In one embodiment of the present invention, such baffles are axially symmetrically arranged along the rotating vessel, drum, or pipe. The angle with the wall of said rotating vessel is in the range of from 5 to 45°, preferably 10 to 20°. By such arrangement, they can transport coated chelating agent (A) very efficiently through the rotating vessel.

In one embodiment of the present invention, said baffles reach in the range of from 10 to 30% into the rotating vessel, referring to the diameter.

In one embodiment of the present invention, said baffles cover in the range of from 10 to 100%, preferably 30 to 80% of the entire length of the rotating vessel. In this context, the term length is parallel to the axis of rotation.

In a preferred embodiment of the present invention the inventive process comprises the step of removing the coated chelating agent (A) from the vessel or vessels, respectively, by pneumatic conveying, e.g. 20 to 100 m/s.

In one embodiment of the present invention, the exhaust gasses are treated with water at a pressure above one bar and even more preferably higher than in the reactor in which steps (b) and (c) are performed, for example in the range of from 1.010 to 2.1 bar, preferably in the range of from 1.005 to 1.150 bar. The elevated pressure is advantageous to compensate for the pressure loss in exhaust lines.

In one embodiment of the present invention, each step (b) and step (c) are performed once. Optionally, however, steps (b) and (c) are repeated once to 25 times.

Repetition may include repeating a sequence of steps (b) and (c) each time under exactly the same conditions or under modified conditions but still within the range of the above definitions. For example, each step (b) may be performed under exactly the same conditions, or, e.g., each step (b) may be performed under different temperature conditions or with a different duration, for example 120° C., then 10° C. and 160° C. each from 1 minute to 1 hour.

In one embodiment of the present invention, steps (b) and (c) are performed at least twice, with moisture in step(s) (c) at last once but in the last sequence, moisture in step (c) is partially or fully replaced by ozone. Such a step is hereinafter also referred to as step (c*).

In step (c*), ozone replaces moisture at least partially. It is preferred that in step (c*) no humidity is applied, and moisture is fully replaced by ozone. Ozone may be generated from oxygen under conditions known per se, and therefore, in step (c*) ozone usually is applied in the presence of oxygen.

During the application of ozone in step (c*) it is preferred that no nitrogen is present.

In one embodiment of the present invention, step (c*) is performed at normal pressure. In another embodiment of the present invention, step (c*) is performed at a pressure of 5 mbar to 1 bar above normal pressure, preferably 10 to 250 mbar above normal pressure. In another embodiment, step (c*) is performed at a pressure below normal pressure, for example at 100 to 900 mbar, preferably at 100 to 500 mbar below normal pressure. Step (c*) may be performed at temperatures from 20 to 300° C., preferred is from 30 to 200° C. and more preferred 50 to 150° C.

In one embodiment of the present invention, the duration of step (c*) is in the range of from 1 minute to 1 hour, preferably from 90 seconds up to 30 minutes.

Step (c*) may be performed in the same type of vessel as step (c). Preferably, steps (c) and (c*) are performed in the same vessel.

A particulate coated chelating agent (A) is obtained.

In one embodiment of the present invention, the sequence of step (b) and step (c*) is performed only once. In another embodiment, the sequence of step (b) and step (c*) is performed two to five times.

In one embodiment of the present invention, after step (c*) or after the last step (c) a post-treatment is performed, for example a thermal post-treatment (e). Such thermal post-treatment (e) may be performed by treating the particulate chelating agent (A) obtained after step (c*) or the last step (c) at a temperature in the range of from 100 to 200° C., preferably from 110 to 150° C., for example over a period of time in the range of from 10 minutes to 2 hours.

In one embodiment of the present invention, such step (e) is performed in a rotary kiln, a free fall mixer, in a continuous vibrating bed or a fluidized bed, for example a stirred fluidized bed.

Another, optional step, is a pre-drying of powder or granule of chelating agent (A) provided in step (a), hereinafter also referred to as step (o). In step (o), said powder or granule of chelating agent (A) is subjected to reduced pressure, for example 10 to 500 mbar (abs), or to a temperature of 75 to 175° C. or to a combination of the foregoing.

The duration of step (o) may be in the range of from 10 minutes to 5 hours.

Step (o) may be performed in the same type of reactor as steps (b) and (c).

A coated granule is obtained that shows low hygroscopicity and a low tendency of yellowing in the presence of peroxide, especially in the presence of percarbonate.

A further aspect of the present invention is directed towards coated granules and coated powders, hereinafter also referring to inventive granules and inventive powders, respectively. Inventive granules and inventive powders contain a chelating agent (A) selected from alkali metal salts of methyl glycine diacetic acid (MGDA) and of glutamic acid diacetic acid (GLDA), and they are coated with an oxide, oxyhydroxide or hydroxide or combinations of at least two of the foregoing of a metal or of silicon.

Preferably, inventive powder or granule has a moisture content in the range of from 1 to 15% by weigh, more preferably from 1.5 to 10.0% by weight.

Inventive powders are particulate materials that are solids at ambient temperature and that preferably have an average particle diameter in the range of from 1 μm to less than 0.1 mm, preferably 10 μm up to 75 μm. The average particle diameter of inventive powders can be determined by, e.g., sieving methods and refers to the volume average (D50).

Inventive granules are particulate materials that are solids at ambient temperature and that preferably have an average particle diameter in the range of from 0.1 mm to 2 mm, more preferably 250 to 850 μm. The average particle diameter of inventive granules can be determined, e.g., by optical or preferably by sieving methods. Sieves employed may have a mesh in the range of from 60 to 1,250 μm (D50).

Inventive granules and powders of contain residual moisture, moisture referring to water including water of crystallization and adsorbed water. The amount of water is in the range of from 1 to 15% by weight, preferably 1.5 to 10% by weight, referring to the total solids content of the respective powder or granule, and may be determined by Karl-Fischer-titration or by thermogravimetric methods.

In one embodiment of the present invention, inventive powder or inventive granule contains at least one additive selected from silica, silicates, inorganic salts, (co)polymers (B) and builders other than chelating agent (A) and organic (co)polymers (B). Such additive(s) may also be referred to as additive(s) (B). Examples of useful additives (B) are, for example, titanium dioxide, sodium carbonate, potassium carbonate, sugar, silica gel, sodium silicate, potassium silicate, and (co)polymers (B) such as, but not limited to poly(meth)acrylates, polyalkylenimines such as polyethylenimines, alkoxylated polyethylenimines, carboxymethylated polyethylenimines, and polyvinyl alcohol. Polyvinyl alcohol in the context of the present invention refers to completely or partially hydrolyzed polyvinyl acetate. In partially hydrolyzed polyvinyl acetate, at least 95 mol %, preferably at least 96 mol-% of the acetate groups have been hydrolyzed. Examples of complexing agents other than aminocarboxylic acid (A) are alkali metal citrates. Another possible class of additives is phosphonates, for example the alkali metal salts of 1-hydroxyethane 1,1-diphosphonic acid, “HEDP”.

In one embodiment of the present invention, inventive powder or granule contains 0.05 to 30% by weight of additive(s) (B) in total, the percentage referring to the entire aqueous slurry. The amount of polyethylenimines or alkoxylated polyethylenimines is preferably in the range of from 0.05 to 0.5% by weight, the amount of silicate may be up to 30% by weight.

Examples of (co)polymers (B) are poly(meth)acrylates including copolymers of (meth)acrylic acid with maleic acid or AMPS, polyalkylenimines, especially polyethylenimines, and substituted polyalkylenimines, for examples polycarboxymethylated polyethylenimines, polycarboxyethylated polyethylenimines, and polyaylkoxylated polyethylenimines, especially polyethoxylated polyethylenimines.

Preferred examples of polycarbomethoxylated polyethylenimines are polyethylenimines in which 20 to 90 mole-% of the N-atoms bear at least one CH₂COO⁻ group, and their respective alkali metal salts, especially their sodium salts.

In one embodiment of the present invention, inventive powder or inventive granule contains in the range of from 80 to 99.9% by weight chelating agent (A) and 0.1 to 20% by weight (co)polymer (B), percentages referring to the total solids content of said aqueous slurry or solution.

In one embodiment of the present invention, (co)polymers (B) selected from poly(meth)acrylic acid have an average molecular weight M_{w} in the range of from 1,200 to 30,000 g/mol, determined by gel permeation chromatography and referring to the respective free acid, if applicable.

In another embodiment of the present invention, inventive powder or granule is free from additive(s) (B).

In a preferred embodiment of the present invention, alkali metal salt of MGDA corresponds to general to general formula (I)

[CH₃—CH(COO)—N(CH₂—COO)₂]M₃₋ₓHₓ (I)

with

M being Na or K or combinations thereof, preferred is Na, and

x being in the range of from zero to 0.5 and corresponding to the average value.

Inventive granules and inventive powders are coated

with an oxide, oxyhydroxide or hydroxide or combinations of at least two of the foregoing of a metal or

with an oxide, oxyhydroxide or hydroxide or combinations of at least two of the foregoing of silicon.

In one embodiment of the present invention, such metal is selected from aluminum and transition metals such as zinc, titanium or zirconium.

Examples of coatings are alumina, aluminum oxyhydroxide, aluminum hydroxide, Al₂O₃·aq, titania, zirconia, titanium oxyhydroxide, zirconium oxyhydroxide, SiO₂, SiO₂·aq, wherein oxyhydroxides of, e.g., Al are not limited to stoichiometric compounds such as AlOOH but any compound of Al that contains both oxide and hydroxide counterions.

Said coating may be continuous or discontinuous. Discontinuous coatings may also be described as the coating having an island structure, with some portions of the particles of the respective powder or granule being covered with (oxy)hydroxide or oxide of metal or of silicon and others being non-coating, resulting in islands of coating on particles of powder or granule and a major uncoated portion, or in islands of non-coated portions on particles of powder or granule and a major coated portion.

However, it is preferred that on inventive granules or powders the coating is a continuous one which means that by methods like transmission electron microscopy (TEM) or scanning electron microscopy (SEM), no non-coated portions may be detected.

The term “discontinuously coated” as used in the context with the present invention refers to at least 80% of the particles of a batch of granule or powder being coated, and to at least 50% up to 95% of the surface of each particle being coated, for example 75 to 95% and preferably 80 to 95%.

In one embodiment of the present invention, said coating has a thickness in the range of from 0.1 to 5 nm, determined by theoretical calculation based on the overall wt % of metal or silicon from step (b) and the assumption of a homogeneous coating on the entire surface of the granules or particles. The specific surface area of the material is determined by nitrogen physisorption measurements and calculations based on the BET theory. Another way to determine the thickness of the coating is electron microscopy imaging of cross-sections of said material. The thickness refers to an average thickness.

Particles of inventive powders of may have regular or irregular shape. Preferred shapes of particles of inventive powders are spheroidal or even spherical shapes. Particles of inventive granules may have regular or irregular shapes. Preferred shapes of particles of inventive granules are spheroidal or even spherical shapes.

Another aspect of the present invention relates to the use of inventive powders and inventive granules, and another aspect of the present invention relates to methods of use of the inventive powders and inventive granules. The preferred use of inventive powders and inventive granules is for the manufacture of solid laundry detergent compositions and of solid detergent compositions for hard surface cleaning. Solid laundry detergent compositions and solid detergent compositions for hard surface cleaning may contain some residual moisture, for example 0.1 to 10% by weight, but are otherwise solid mixtures. The residual moisture content may be determined, e.g., under vacuum at 80° C. Another aspect of the present invention relates to solid laundry detergent compositions and to solid detergent compositions for hard surface cleaning.

In the context of the present invention, the term “detergent composition for cleaners” includes cleaners for home care and for industrial or institutional applications. The term “detergent composition for hard surface cleaners” includes compositions for dishwashing, especially hand dishwash and automatic dishwashing and ware-washing, and compositions for other hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, but not laundry detergent compositions.

In the context of the present invention and unless expressly stated otherwise, percentages in the context of ingredients of laundry detergent compositions are percentages by weight and refer to the total solids content of the respective laundry detergent composition. In the context of the present invention and unless expressly stated otherwise, percentages in the context of ingredients of detergent composition for hard surface cleaning are percentages by weight and refer to the total solids content of the detergent composition for hard surface cleaner.

In one embodiment of the present invention, solid laundry detergent compositions according to the present invention may contain in the range of from 1 to 30% by weight of inventive powder or inventive granule, respectively. Percentages refer to the total solids content of the respective laundry detergent composition.

In one embodiment of the present invention, inventive solid detergent compositions for hard surface cleaning may contain in the range of from 1 to 50% by weight of inventive powder or inventive granule, respectively, preferably 5 to 40% by weight and even more preferably 10 to 25% by weight. Percentages refer to the total solids content of the respective detergent composition for hard surface cleaning.

Particularly advantageous inventive solid detergent compositions for hard surface cleaning and inventive solid laundry detergent compositions, especially for home care, may contain one or more complexing agent other than inventive powder and inventive granule. Inventive solid detergent compositions for hard surface cleaning and inventive solid laundry detergent compositions may contain one or more complexing agent (in the context of the present invention also referred to as sequestrant) other than an inventive powder or inventive granule. Examples are citrate, phosphonic acid derivatives, for example the disodium salt of hydroxyethane-1,1-diphosphonic acid (“HEDP”), and polymers with complexing groups like, for example, polyethyleneimine in which 20 to 90 mole-% of the N-atoms bear at least one CH₂COO⁻ group, and their respective alkali metal salts, especially their sodium salts, for example GLDA-Na₄, IDSNa₄, and trisodium citrate, and phosphates such as STPP (sodium tripolyphosphate). Due to the fact that phosphates raise environmental concerns, it is preferred that advantageous detergent compositions for cleaners and advantageous laundry detergent compositions are free from phosphate. “Free from phosphate” should be understood in the context of the present invention, as meaning that the content of phosphate and polyphosphate is in sum in the range from 10 ppm to 0.2% by weight, determined by gravimetry.

Preferred inventive solid detergent compositions for hard surface cleaning and preferred inventive solid laundry detergent compositions may contain one or more surfactant, preferably one or more non-ionic surfactant.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (III)

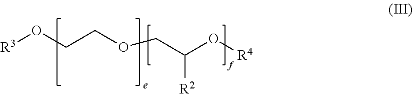

in which the variables are defined as follows:
R² is identical or different and selected from hydrogen and linear C₁-C₁₀-alkyl, preferably in each case identical and ethyl and particularly preferably hydrogen or methyl,
R₃ is selected from C₈-C₂₂-alkyl, branched or linear, for example n-C₈H₁₇, n-C₁₀H₂₁, n-C₁₂H₂₅, n-C₁₄F₁₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

m and n are in the range from zero to 300, where the sum of n and m is at least one, preferably in the range of from 3 to 50. Preferably, m is in the range from 1 to 100 and n is in the range from 0 to 30.

In one embodiment, compounds of the general formula (III) may be block copolymers or random copolymers, preference being given to block copolymers.

Other preferred examples of alkoxylated alcohols are, for example, compounds of the general formula (IV)

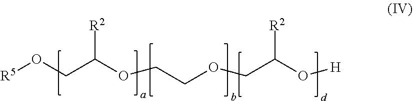

in which the variables are defined as follows:
R² is identical or different and selected from hydrogen and linear C₁-C₀-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈F₁₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Preferred examples for hydroxyalkyl mixed ethers are compounds of the general formula (V)

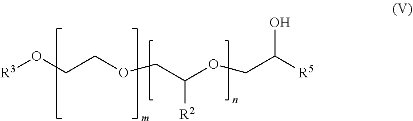

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example iso-C₁₁H₂₃, iso-C₁₃H₂₇, nC₈H₁₇, n-C₁₀H₂₁, n-C₁₂H₂₅, n-C₁₄H₂₉, n-C₁₆H₃₃ or n-C₁₈H₃₇,
R⁵ is selected from C₆-C₂₀-alkyl, for example n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and noctadecyl.

The variables m and n are in the range from zero to 300, where the sum of n and m is at least one, preferably in the range of from 5 to 50. Preferably, m is in the range from 1 to 100 and n is in the range from 0 to 30.

Compounds of the general formula (IV) and (V) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (VI) are likewise suitable.

wherein:

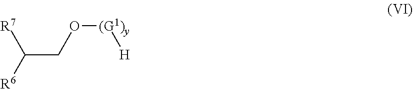

R⁶ is C₁-C₄-alkyl, in particular ethyl, n-propyl or isopropyl,
R⁷ is —(CH₂)₂-R⁶,
G¹ is selected from monosaccharides with 4 to 6 carbon atoms, especially from glucose and xylose,
y in the range of from 1.1 to 4, y being an average number,

Further examples of non-ionic surfactants are compounds of general formula (VII) and (VIII)

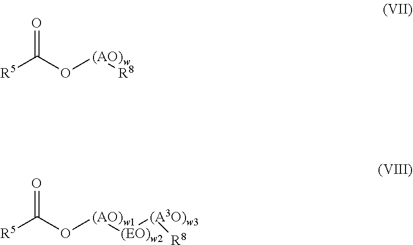

AO is selected from ethylene oxide, propylene oxide and butylene oxide,

EO is ethylene oxide, CH₂CH₂—O,

R⁸ selected from C₈-C₁₈-alkyl, branched or linear, and R⁵ is defined as above.

A³O is selected from propylene oxide and butylene oxide,

w is a number in the range of from 15 to 70, preferably 30 to 50,

w1 and w3 are numbers in the range of from 1 to 5, and

w2 is a number in the range of from 13 to 35.

An overview of suitable further nonionic surfactants can be found in EP-A 0 851 023 and in DEA 198 19 187.

Mixtures of two or more different nonionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (IX)

R⁹R¹⁰R¹¹N→O (IX)

wherein R⁹, R¹⁰, and R¹¹ are selected independently from each other from aliphatic, cycloaliphatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁰ and R¹¹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Examples of suitable anionic surfactants are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Further examples for suitable anionic surfactants are soaps, for example the sodium or potassium salts of stearic acid, oleic acid, palmitic acid, ether carboxylates, and alkylether phosphates.

Preferably, inventive laundry detergent compositions contain at least one anionic surfactant.

In one embodiment of the present invention, inventive solid laundry detergent compositions may contain 0.1 to 60% by weight of at least one surfactant, selected from anionic surfactants, amphoteric surfactants and amine oxide surfactants.

In one embodiment of the present invention, inventive solid detergent compositions for cleaners may contain 0.1 to 60% by weight of at least one surfactant, selected from anionic surfactants, amphoteric surfactants and amine oxide surfactants.

In a preferred embodiment, inventive solid detergent compositions for cleaners and especially those for automatic dishwashing do not contain any anionic surfactant.

Inventive solid detergent compositions for hard surface cleaning and inventive solid laundry detergent compositions may contain at least one bleaching agent, also referred to as bleach. Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate.

Examples of organic peroxide bleaches are organic percarboxylic acids, especially organic percarboxylic acids.

In inventive solid detergent compositions for hard surface cleaning and in inventive solid laundry detergent compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive solid detergent compositions for hard surface cleaning and inventive solid laundry detergent compositions may comprise, for example, in the range from 3 to 10% by weight of chlorine-containing bleach.

Inventive solid detergent compositions for hard surface cleaning and inventive solid laundry detergent compositions may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive solid detergent compositions for hard surface cleaning and inventive solid laundry detergent compositions may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

Inventive solid detergent compositions for hard surface cleaning and inventive solid laundry detergent compositions may comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, inventive solid detergent compositions for hard surface cleaning and inventive solid laundry detergent compositions comprise in total in the range from 0.1 to 1.5% by weight of corrosion inhibitor.

Inventive solid detergent compositions for hard surface cleaning and inventive solid laundry detergent compositions may comprise one or more builders, selected from organic and inorganic builders. Examples of suitable inorganic builders are sodium sulfate or sodium carbonate or silicates, in particular sodium disilicate and sodium metasilicate, zeolites, sheet silicates, in particular those of the formula α-Na₂Si₂O₅, β-Na₂Si₂O₅, and δ-Na₂Si₂O₅, also fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, and polymeric builders, for example polycarboxylates and polyaspartic acid.

Examples of organic builders are especially polymers and copolymers. In one embodiment of the present invention, organic builders are selected from polycarboxylates, for example alkali metal salts of (meth)acrylic acid homopolymers or (meth)acrylic acid copolymers.

Suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M_{w} in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of builders is carboxymethyl inulin. Moreover, amphoteric polymers can also be used as builders.

Inventive solid detergent compositions for hard surface cleaning and inventive solid laundry detergent compositions may comprise, for example, in the range from in total 10 to 70% by weight, preferably up to 50% by weight, of builder. In the context of the present invention, MGDA is not counted as builder.

In one embodiment of the present invention, inventive solid detergent compositions for hard surface cleaning and inventive solid laundry detergent compositions may comprise one or more cobuilders.

Inventive solid detergent compositions for hard surface cleaning and inventive solid laundry detergent compositions may comprise one or more antifoams, selected for example from silicone oils and paraffin oils.

In one embodiment of the present invention, inventive solid detergent compositions for hard surface cleaning and inventive solid laundry detergent compositions comprise in total in the range from 0.05 to 0.5% by weight of antifoam.

Inventive solid detergent compositions for hard surface cleaning and inventive solid laundry detergent compositions may comprise one or more enzymes. Examples of enzymes are lipases, hydrolases, amylases, proteases, cellulases, esterases, pectinases, lactases and peroxidases.

In one embodiment of the present invention, inventive solid detergent compositions for hard surface cleaning and inventive solid laundry detergent compositions may comprise, for example, up to 5% by weight of enzyme, preference being given to 0.1 to 3% by weight. Said enzyme may be stabilized, for example with the sodium salt of at least one C₁-C₃-carboxylic acid or C₄-C₁₀-dicarboxylic acid. Preferred are formates, acetates, adipates, and succinates.

In one embodiment of the present invention, inventive solid detergent compositions for hard surface cleaning and inventive solid laundry detergent compositions comprise at least one zinc salt. Zinc salts can be selected from water-soluble and water-insoluble zinc salts. In this connection, within the context of the present invention, water-insoluble is used to refer to those zinc salts which, in distilled water at 25° C., have a solubility of 0.1 g/l or less. Zinc salts which have a higher solubility in water are accordingly referred to within the context of the present invention as water-soluble zinc salts.

In one embodiment of the present invention, zinc salt is selected from zinc benzoate, zinc gluconate, zinc lactate, zinc formate, ZnCl₂, ZnSO₄, zinc acetate, zinc citrate, Zn(NO₃)₂, Zn(CH₃SO₃)₂ and zinc gallate, preferably ZnCl₂, ZnSO₄, zinc acetate, zinc citrate, Zn(NO₃)₂, Zn(CH₃SO₃)₂ and zinc gallate.

In another embodiment of the present invention, zinc salt is selected from ZnO, ZnO·aq, Zn(OH)₂ and ZnCO₃. Preference is given to ZnO·aq.

In one embodiment of the present invention, zinc salt is selected from zinc oxides with an average particle diameter (weight-average) in the range from 10 nm to 100 μm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH of mixture according to the invention is adjusted, zinc salt can change. Thus, it is for example possible to use zinc acetate or ZnCl₂ for preparing formulation according to the invention, but this converts at a pH of 8 or 9 in an aqueous environment to ZnO, Zn(OH)₂ or ZnO·aq, which can be present in non-complexed or in complexed form.

Zinc salt may be present in those detergent compositions for cleaners according to the invention which are solid at room temperature are preferably present in the form of particles which have for example an average diameter (number-average) in the range from 10 nm to 100 μm, preferably 100 nm to 5 μm, determined for example by X-ray scattering.

Zinc salt may be present in those detergent compositions for home which are liquid at room temperature in dissolved or in solid or in colloidal form.

In one embodiment of the present invention, detergent compositions for cleaners and laundry detergent compositions comprise in total in the range from 0.05 to 0.4% by weight of zinc salt, based in each case on the solids content of the composition in question.

Here, the fraction of zinc salt is given as zinc or zinc ions. From this, it is possible to calculate the counterion fraction.

In one embodiment of the present invention, inventive solid detergent compositions for hard surface cleaning and inventive solid laundry detergent compositions are free from heavy metals apart from zinc compounds. Within the context of the present, this may be understood as meaning that detergent compositions for cleaners and laundry detergent compositions according to the invention are free from those heavy metal compounds which do not act as bleach catalysts,

in particular of compounds of iron and of bismuth. Within the context of the present invention, “free from” in connection with heavy metal compounds is to be understood as meaning that the content of heavy metal compounds which do not act as bleach catalysts is in sum in the range from 0 to 100 ppm, determined by the leach method and based on the solids content. Preferably, formulation according to the invention has, apart from zinc, a heavy metal content below 0.05 ppm, based on the solids content of the formulation in question. The fraction of zinc is thus not included.

Within the context of the present invention, “heavy metals” are defined to be any metal with a specific density of at least 6 g/cm³ with the exception of zinc. In particular, the heavy metals are metals such as bismuth, iron, copper, lead, tin, nickel, cadmium and chromium.

Preferably, inventive solid detergent compositions for hard surface cleaning and inventive solid laundry detergent compositions comprise no measurable fractions of bismuth compounds, i.e. for example less than 1 ppm.

In one embodiment of the present invention, inventive solid detergent compositions for hard surface cleaning and inventive solid laundry detergent compositions comprise one or more further ingredient such as fragrances, dyestuffs, organic solvents, buffers, disintegrants for tabs, and/or acids such as methylsulfonic acid.

Preferred example detergent compositions for automatic dishwashing may be selected according to Table 1.

TABLE 1
Example detergent compositions for automatic dishwashing

| All amounts in g/sample | ADW.1 | ADW.2 | ADW.3 |
|---|---|---|---|
| inventive granule, racemic MGDA- | 30 | 22.5 | 15 |
| Na₃, (D50): 550 μm, coated with | | | |
| TMA/H₂O | | | |
| Protease | 2.5 | 2.5 | 2.5 |
| Amylase | 1 | 1 | 1 |
| n-C₁₈H₃₇—O(CH₂CH₂O)₉H | 5 | 5 | 5 |
| Polyacrylic acid M_{w} 4000 g/mol as | 10 | 10 | 10 |
| sodium salt, completely neutralized | | | |
| Sodium percarbonate | 10.5 | 10.5 | 10.5 |
| TAED | 4 | 4 | 4 |
| Na₂Si₂O₅ | 2 | 2 | 2 |
| Na₂CO₃ | 19.5 | 19.5 | 19.5 |
| Sodium citrate dihydrate | 15 | 22.5 | 30 |
| HEDP | 0.5 | 0.5 | 0.5 |
| ethoxylated polyethylenimine, 20 | option- | option- | option- |
| EO/NH group, Mₙ: 30,000 g/mol | ally: 0.1 | ally: 0.1 | ally: 0.1 |

Laundry detergent compositions according to the invention are useful for laundering any type of laundry, and any type of fibres. Fibres can be of natural or synthetic origin, or they can be mixtures of natural of natural and synthetic fibres. Examples of fibers of natural origin are cotton and wool. Examples for fibers of synthetic origin are polyurethane fibers such as Spandex® or Lycra®, polyester fibers, or polyamide fibers. Fibers may be single fibers or parts of textiles such as knitwear, wovens, or nonwovens.

The invention is further illustrated by a working example.

General: the moisture content was determined by thermogravimetry: heating up to 300° C. in inert gas in a thermogravimetric analysis setup and constant weighing of the sample and online off-gas analysis by e.g. infrared or mass spectrometry. The moisture content can then be calculated from the weight loss.

Nl: liter at normal conditions, 1 bar and 23° C.

Manufacture of Inventive Granules

I.1 Manufacture of Inventive Granule Gr.1

Step (a.1): a granule of MGDA-Na₃, (A.1), ee value of 20% in favour of the L-enantiomer, with an average particle diameter (D50) of 800 μm was provided. It was obtained by spray-granulation of an aqueous solution of MGDA-Na₃. Its residual moisture content was 12.5% by weight.

A rotated overflown bed reactor (reactor) with external heating jacket was charged with 100 g of (A.1).

Step (o.1) At an average pressure of 10 mbar, (A.1) was moved by the rotation of the reactor. The reactor was heated to 150° C. and maintained at 150° C. for 3 h under constant rotation. The residual moisture dropped to about 6% by weight.

The reactor was then heated to 150° C. and kept at 150° C. for 3 hours at a reduced pressure of mbar. Then, the pressure was increased to 1030 mbar.

Step (b.1-1): Trimethylaluminum (TMA) in the gaseous state was introduced into the fluidized bed reactor by pumping a gas flow dry N₂ (carrier gas) through a saturator that contained a reservoir that contained TMA in liquid form at 23° C. The gas flow of the combine TMA and N₂ was 5 Nl/h. After a reaction period of 15 minutes, step TMA could be detected in the off-gas stream and (b.1-1) was finished.

Purging/flushing step 1TMA: non-reacted TMA and CH₄ formed were removed through a nitrogen stream, and the reactor is purged with nitrogen for additional 15 minutes with a flow of 5 Nl/hour and 150° C.

Step (c.1-1): Water in the gaseous state was introduced into the reactor in the same manner as the TMA for 10 min but with water instead of TMA.

Purging step 1 water: The above purging was repeated over a period of 15 minutes.

Step (d.1): The sequence of the steps (b.1-1), purge 1TMA, (c.1-1) and purge 1 water was repeated five times. However, in the last purging step, purge 5 water, the reactor was purged with nitrogen for 90 minutes.

An inventive coated MGDA-Na₃ granule, IG.1, was obtained with an overall AI content of 0.25 wt % and superior color stability. The moisture content of IG.1 was 9.1% and the average diameter (d50) was 800 μm. By TEM, it could be shown that the coating was continuous: no non-coated portions were detected.

I.2 Manufacture of Inventive Granule IG.2

The experiment of 1.1 was repeated but ten cycles were performed instead of 5, and the temperature was set to 50° C. in steps (b2-1) and (c2-1) and (d.2).

An inventive coated MGDA-Na 3 granule, IG.2, was obtained with an overall AI content of 0.32 wt % and superior color stability. The moisture content of IG.2 was about 9% and the average diameter (d50) was 800 μm. By TEM, it could be shown that the coating was continuous: no non-coated portions were detected.

I.3 Manufacture of Inventive Granule IG.3

The experiment of 1.1 was repeated but only one cycle was performed, and the temperature was set to 50° C. in steps (b3-1) and (c3-1) and (d.3).

An inventive coated MGDA-Na₃ granule, IG.3, was obtained with an overall AI content of 0.10 wt % and superior color stability. The moisture content of IG.3 was about 9% and the average diameter (d50) was 800 μm. By TEM, it could be shown that the coating was non-continuous: non-coated portions were detected.

I.4 Manufacture of Inventive Granule IG.4

The experiment of 1.1 was repeated but the temperature was set to 50° C. in steps (b4-1) and (c4-1) and (d.4).

An inventive coated MGDA-Na₃ granule, IG.4, was obtained with superior color stability. The moisture content of IG.4 was about 9% and the average diameter (d50) was 800 μm. By TEM, it could be shown that the coating was continuous: no non-coated portions were detected.

Testing of Yellowing Behavior

10 g of the respective inventive particles or comparative particles were mixed with 5 g Na-percarbonate and placed in a cell culture bottle with a semi permeable membrane to allow an exchange with the surrounding atmosphere. The vial was stored for 26 days in a climate-chamber at 35° C. and 70% humidity.

The discoloration—which is a yellowing in this case—of the stored mixtures was determined by measuring the b-value of the CIELAB color space (Elrepho measurement).

Peroxide Test:
(P.1): start value
(P.2): discoloration after storage for 12 days (delta to start)
(P.3): discoloration after storage for 19 days, delta to (P.2)
(P.4): discoloration after storage for 28 days, delta to (P.3)

TABLE 2
Results of yellowing tests

| | Cycles | T/° C. | (P.1) | (P.2) | (P.3) | (P.4) |
|---|---|---|---|---|---|---|
| (a.1) | Zero | — | 0 | 13.70 | 18.29 | 20.61 |
| IG.1 | 5 | 150 | 0 | 1.075 | 8.01 | 18.10 |
| IG.2 | 10 | 50 | 0 | 1.93 | 9.82 | 23.20 |
| IG.3 | 1 | 50 | 0 | 6.41 | 17.26 | 22.45 |
| IG.4 | 5 | 50 | 0 | 8.48 | 18.62 | 21.68 |

T refers to steps (b) and (c).

1. A process for making a particulate coated chelating agent (A) comprising the following steps:
(a) providing a granule or powder containing an alkali metal salt of methyl glycine diacetic acid (MGDA) or glutamic acid diacetic acid (GLDA),
(b) treating said salt with a metal alkoxide or metal halide or metal amide or alkyl metal compound, or with an alkoxide, amide, halide or alkyl compound of silicon,
(c) treating the material obtained in step (b) with moisture, or
(c*) with ozone,
(d) repeating the sequence of steps (b) and (c) once to 25 times.

2. The process according to claim 1, wherein said alkali metal salt of MGDA corresponds to general formula (I)
[CH₃—CH(COO)—N(CH₂—COO)₂]M₃₋ₓHₓ (I)
with
M being Na or K or combinations thereof,
x being in the range of from zero to 0.5 and corresponding to the average value.

3. The process according to claim 1, wherein step (b) is performed in a rotary kiln, a free fall mixer, in a continuous vibrating bed or a fluidized bed.

4. The process according to claim 1, wherein the alkyl metal compound in step (b) is trimethylaluminum, triethylaluminum, diethyl zinc, or wherein the silicon amide in step (b) is tris-dimethylamino silane or mono-dimethylaminosilane.

5. The process according to claim 1, wherein between each step (b) and (c) and (d), if applicable, a flushing step is performed, said flushing step having a duration in the range of from one to 60 minutes.

6. The process according to claim 1, wherein steps (b) to (c) and, if applicable, step (d) are performed in a fluidized bed or in a rotary reactor.

7. The process according to claim 1, wherein steps (b) and (c) are performed at a temperature in the range of from 40 to 175° C.

8. The process according to claim 1, wherein granules have an average particle diameter D50 in the range of from 250 to 850 μm, determined by sieving methods.

9. A granule or powder comprising a chelating agent (A) selected from alkali metal salts of methyl glycine diacetic acid (MGDA) and of glutamic acid diacetic acid (GLDA) and coated with an oxide of a metal, wherein the coating is a continuous one, determined by transmission electron spectroscopy, in that no non-coated portions may be detected, and wherein said coating has a thickness in the range of from 0.1 nm to 5 nm.

10. (canceled)

11. The granule or powder according to claim 9, wherein the metal is aluminum, zinc, titanium or zirconium.

12. The granule according to claim 9, wherein said granule has an average particle diameter D50 in the range of from 250 to 850 μm, determined by sieving methods.

13. (canceled)

14. A method of manufacturing a solid composition for automatic dishwashing, comprising combining a granule or a powder according to claim 9 with a bleaching agent and a surfactant.

15. A method of manufacturing a solid composition for automatic dishwashing, comprising combining a granule or a powder according to claim 11 with a bleaching agent and a surfactant.

16. A method of manufacturing a solid composition for automatic dishwashing, comprising combining a granule according to claim 12 with a bleaching agent and a surfactant.

17. The granule according to claim 11, wherein said granule has an average particle diameter D50 in the range of from 250 to 850 μm, determined by sieving methods.
